(19) United States
(12) Patent Application Publication
(10) Pub. No.: US 2025/0265756 A1
(43) Pub. Date: Aug. 21, 2025

(54) METHOD FOR GENERATING AUDIO-BASED ANIMATION WITH CONTROLLABLE EMOTION VALUES AND ELECTRONIC DEVICE FOR PERFORMING THE SAME.

(71) Applicant: FluentT Inc., Seoul (KR)

(72) Inventors: Young In KIM, Daegu (KR); O Yeon KWON, Seoul (KR); Yechan JEON, Seoul (KR)

(21) Appl. No.: 18/644,124

(22) Filed: Apr. 24, 2024

(30) Foreign Application Priority Data
Feb. 19, 2024 (KR) 10-2024-0023757

(51) Int. Cl. G06T 13/20; G06T 13/40; G10L 15/02; G10L 15/06; G10L 25/63

(52) U.S. Cl. CPC G06T 13/205; G06T 13/40; G10L 15/02; G10L 15/063; G10L 25/63

(57) ABSTRACT

The example embodiment is an audio-based animation generation device capable of adjusting emotions, the device comprising a memory storing one or more instructions and at least one processor, wherein the at least one processor performs operations of receiving an audio source by executing the stored instructions; inputting the audio source into a pre-training feature extractor to extract at least one voice-based first control function for generating an emotion-adjustable animation; determining conditional features through at least one first feature extracted based on the first control function, at least one second feature extracted based on reference data, and at least one third feature extracted based on animation data; training a training module to generate an emotion-adjustable animation based on the conditional features; and generating an emotion animation through an reference module based on a target audio source and a target image input value.

### BACKGROUND

### 1. Technical Field

The present invention relates to a method for generating an animation based on audio and/or voices, and more particularly to a method for generating an animation capable of controlling not only voices but also emotions.

### 2. Discussion of the Related Art

Recently, with the rapid development of virtual reality (VR), augmented reality (AR), and social media platforms, there is a growing demand for technologies that increase the sense of user immersion and enhance user interaction. In this environment, a three-dimensional (3D) animation generation technology based on human voice is highly applicable in various fields such as communication through virtual characters or avatar, games, entertainment, education, virtual conference, and more.

In the related art, there is a technology that generates a 3D animation using human voices, but the method is limited to determining the movement of the animation based simply on the pitch or intensity of the voice. Such a method has a limitation in delivering subtle nuances of emotions contained in the user's voice. Moreover, most of the related art is a method for generating animations based on pre-recorded voices, and there are many drawbacks for real-time interaction.

Therefore, there is a need for developing a technology that extracts subtle changes in emotions inherent in human voices through a technology that accurately extracts and analyzes emotions from human voices, and it generates 3D animations reflecting the same. Furthermore, there is a need for a technology that allows users to create virtual characters or avatars that instantly reflect the user's emotional changes during conversations or interactions through real-time conversion technology.

### SUMMARY

The example embodiment is to provide a method for generating real-time facial expressions based on audio/voice signals obtained from a user, and furthermore, accurately extracting emotions from the voice and generating an animation reflecting the same.

In a device for generating an audio/voice-based animation capable of adjusting emotions, the device includes a memory storing one or more instructions and at least one processor, wherein the at least one processor performs an operation of receiving an audio/voice source by executing the stored instructions, an operation of extracting at least one audio/voice-based first control function for generating an animation capable of adjusting emotions by inputting the audio/voice source to a pre-training feature extractor, an operation of determining a conditional feature through at least one first feature extracted based on the first control function, at least one second feature extracted based on reference data, and at least one third feature extracted based on animation data, an operation of training a training module to generate an animation capable of adjusting emotions based on the conditional feature, and an operation of generating an animation based on a target audio/voice source and a target image input value through an referencing module, wherein the emotion animation may be adjusted in a degree of emotion based on the first control function.

According to the example embodiment, by accurately extracting emotions from the user's voice and reflecting them in the animation, the expressions and gestures of the animation character can be more naturally expressed, thereby making the interaction between the user and the virtual character much more natural and meaningful and significantly enhancing the immersion.

According to the example embodiment, through the real-time animation generation technology, it is possible to provide animations that instantly reflects the user's emotional changes in real time during conversations or other communication, thereby providing a communication experience that is much closer to real time in the virtual space.

The example embodiments or the effects of the embodiments are not limited to those mentioned above. A better understanding of the nature and advantages of embodiments of the present invention may be gained by ones having ordinary skill in the art with reference to the following detailed description and the accompanying drawings.

### BRIEF DESCRIPTION OF THE DRAWINGS

FIG. 1 is a diagram illustrating an audio-based animation generation device according to an embodiment.

FIG. 2 is a diagram illustrating an operation method of an animation generation device according to an embodiment.

FIG. 3 is a diagram illustrating a method of generating emotion animation according to an embodiment.

FIGS. 4 to 8 are diagrams illustrating a plurality of modules constituting an electronic device according to an embodiment.

FIG. 9 is a diagram illustrating a multi-modal-based animation generation method according to an embodiment.

FIGS. 10 to 12 are diagrams illustrating a process for multi-modal-based animation generation according to an embodiment.

FIGS. 13 and 14 are diagrams illustrating a specific example of a multi-modal-based animation generation method according to an embodiment.

### DETAILED DESCRIPTION OF THE EMBODIMENTS

The objects, features, and advantages of the present disclosures will become more apparent from the following detailed description and the accompanying drawings. The example embodiments herein have been presented for the purpose of explaining the principles of the invention and its various applications; thereby enabling ones skilled in the art to utilize the invention and to understand the embodiments with many modifications and variations.

Throughout the specification, the same reference numbers indicate the same elements. In addition, the functions of the same elements within the same scope and spirit of the invention shown in the drawings of each embodiment will be described using the same reference numbers, and duplicate descriptions thereof will be omitted.

If it is determined that the detailed description of a known function or configuration related to the present invention may unnecessarily obscure the subject matter of the present invention, the detailed description will be omitted. Also, the numbers (e.g., first, second, etc.) used in the present specification are mere identifiers for distinguishing one element from another element and do not imply a sequential or hierarchical order unless the context clearly indicates otherwise.

In addition, the suffix “module” and “unit” for the elements used in the example embodiments are granted or used merely for ease of drafting the specification, and they do not possess distinct meanings or functions that set them apart from one another.

As used in the description of the example embodiments and the claims, the singular forms “a”, “an” and “the” are intended to include the plural forms as well, unless the context clearly indicates otherwise. It will also understood that the symbol “/” and “and/or” as used herein refer to and encompass any and all possible combinations of one or more of the associated listed items.

In the embodiments, the expression “include(s)” or “have/has” means that features, numbers, steps, operations, elements, parts, or combinations thereof described in the specification are present, but it does not preclude the presence or addition of one or more other features, numbers, steps, operations, elements, parts, or combinations thereof.

In the drawings, the sizes of the elements may be exaggerated or reduced for ease of explanation. For example, the sizes and thicknesses of each configuration shown in the drawings are arbitrarily illustrated for convenience of description and the embodiment is not necessarily limited to the illustration.

When some embodiments are implemented differently, the order of a specific process may be performed differently from the order described. For example, two processes described consecutively may be performed simultaneously or substantially at the same time, or it may be performed in the reverse order.

When an element is said to be “connected” or “coupled” to another element in the embodiment, it includes not only the case where the element is directly connected or coupled to the other element but also the case where the element is indirectly connected or coupled to the other element interposed between them. For example, when an element is said to be electrically connected in the embodiment, it includes not only the case where the element is directly connected but also the case where the element is indirectly connected to other elements interposed between them.

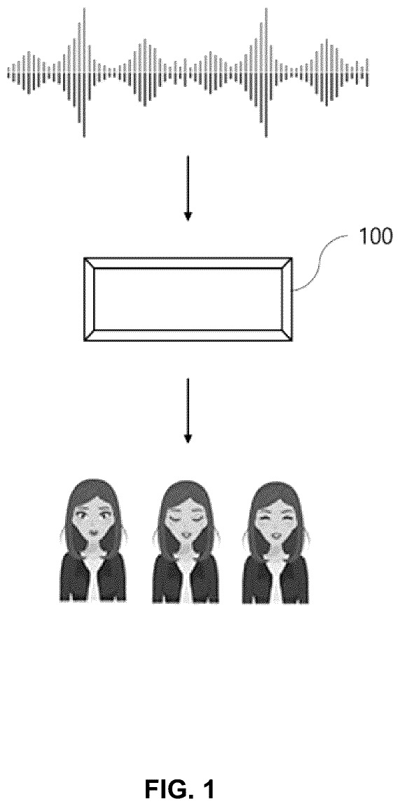

FIG. 1 is a diagram illustrating an audio-based animation generation device according to an embodiment. Referring to FIG. 1, the animation generation device according to the embodiment may generate an animation based on an audio/voice signal obtained from a user. The animation generation device may obtain audio/voice signals from the user and input the audio/voice signals to the animation generation device (100), and it may generate animations corresponding to the obtained audio/voice signals through a pre-trained model (100).

The audio signal may be an electrical representation of a source including human voice, music, or other various sounds. In this embodiment, the audio signal refers to voice data generated by the user, which may be obtained and processed by the animation generation device. The audio signal includes not only the user's voice but also the nuance and characteristics of the emotions contained in the voice, and in the animation generation step, such audio signals may be analyzed to recognize the user's voice and emotional state, and based on this, the 3D animation character may be expressed by reflecting the user's voice and emotions.

The animation generation device (100) may be an electronic device including a pre-trained model. The animation generation device (100) may be an electronic device driven by the pre-trained model. The animation generation device (100) may be an electronic device such as a user terminal and may be in the form of a server. Hereinafter, for the convenience of explanation, the animation generation device (100) is referred to as an electronic device.

The electronic device (100) may include a memory storing one or more instructions, a communicator unit communicating with an external device, an input/output interface receiving a user's input, and at least one processor generating a control signal.

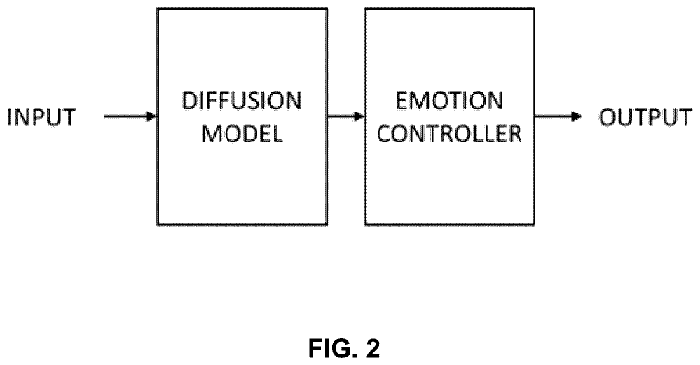

FIG. 2 is a diagram illustrating an operation method of an animation generation device according to an embodiment. Referring to FIG. 2, the electronic device (100) according to the embodiment may obtain an audio source from a user and generate an animation by using the audio source as an input value of a first model (e.g., diffusion model). The electronic device (100) may output an animation with controlled emotion values by using the animation generated based on the audio source as the input value of the second model (e.g., emotion controller).

The diffusion model is one of the deep learning-based generative models, which may use a method of generating new data by learning the data distribution. The model may operate in a way of learning the data distribution through the process of gradually adding noise and then generating new data similar to the original data by gradually removing the noise.

The diffusion model disclosed herein may be a model that is trained to generate the movement of a 3D animation character based on the obtained audio signal an input. In this process, the diffusion model may analyze the characteristics of the audio signal to capture the tone, speed, and emotion, etc. of the voice and convert them into the movement and expression of the animation character.

The emotion controller may perform an operation of adjusting and controlling the emotion value with respect to the generated animation. The model may reflect the emotions in the expression, gesture, and behavior of the animation character based on the emotion data extracted from the audio signal, thereby enabling more natural and realistic emotional expression. For example, if joy is detected in the user's voice, the emotion controller may adjust the animation character to smile, and on the contrary, if sadness is detected, it may adjust the character's expression and gestures to indicate the sadness. Through this process, the emotion controller can improve the quality of virtual interaction by allowing the animation character to accurately reflect the user's emotion.

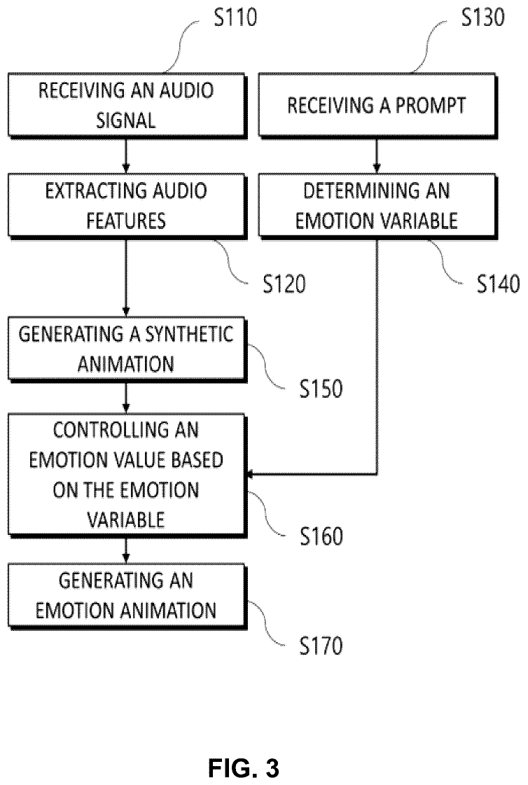

FIG. 3 is a diagram illustrating a method of generating an emotion animation according to an embodiment. Referring to FIG. 3, the method for generating the emotion animation according to an embodiment may include a step of receiving an audio signal (S110), a step of extracting audio features (S120), a step of receiving a prompt (S130), a step of determining an emotion variable (S140), a step of generating a synthetic animation (S150), a step of controlling an emotion value based on the emotion variable (S160), and a step of generating an emotion animation (S170).

The electronic device (100) may obtain an audio signal from a user. The electronic device (100) may extract audio features based on analysis of audio signals obtained from the user. For example, the electronic device (100) may extract audio attributes such as pitch, intensity, timbre, duration, and melody based on the analysis of the audio signal, and the audio features may be determined based on the analysis.

The electronic device (100) may generate a synthetic animation based on the audio features. The electronic device (100) may generate the synthetic animation through a method of synthesizing the movement (or motion, expression) of the 3D animation character based on the audio features extracted by the above-mentioned method. More specifically, the electronic device (100) may generate a synthetic animation reflecting the user's voice by adjusting the character's mouth shape, facial expression, and gestures using the animation parameter associated with the audio features described above.

The electronic device (100) may generate an emotion animation by reflecting emotional information obtained by a predetermined method in the synthetic animation. The electronic device (100) may extract emotional information based on the audio signal and generate an emotion animation that has been emotionally controlled based on the emotional information with respect to the synthetic animation.

The electronic device (100) may quantitatively classify the user's emotional state through the analysis of the audio signal and convert it into an emotion variable. The electronic device (100) may extract emotional features from tones, speeds, and heights of voices using known machine learning and natural language processing techniques.

The electronic device (100) may obtain a prompt from a user. The prompt may be provided in one of the forms of text image, video form, and animation.

The electronic device (100) may extract an emotion variable from the prompt. For example, the electronic device (100) may the extract emotion variables through analysis of prompts input by a user. Here, the method of extracting the emotion variables from the prompts by the electronic device (100) may be the same as described above.

More specifically, users may input prompts to induce the generation of an animation reflecting their desired emotions. The electronic device (100) may extract at least one of emotions through the analysis of the prompts, and it may determine an emotion variable in consideration of weight for each emotion.

The electronic device (100) may generate the emotion animation by further considering the emotion variables determined based on the prompts in the same method described above. That is, the electronic device (100) may generate the emotion animation by considering both the emotion variables extracted from the audio signal and the emotion variables extracted based on the prompts.

In this case, the electronic device (100) may generate the emotion animation based on the synthetic animation by reflecting the weight for the first emotion determined based on the prompts.

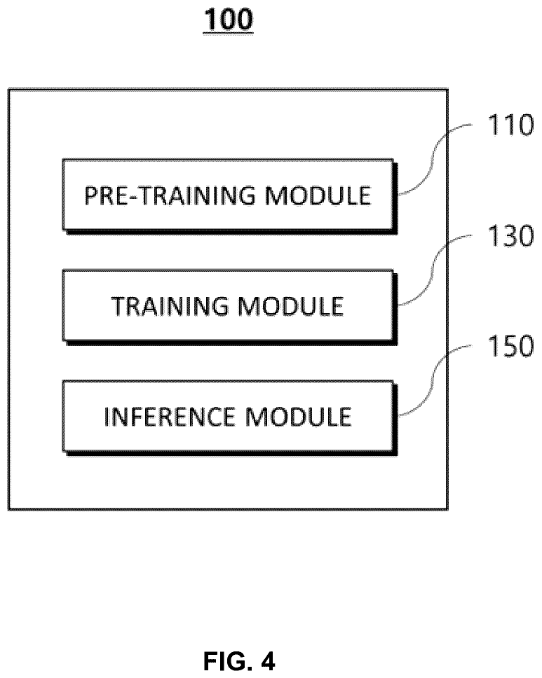

FIGS. 4 to 8 are diagrams illustrating various modules constituting an electronic device according to an embodiment. Referring to FIG. 4, the electronic device (100) according to an embodiment may include a pre-training module (110), a training module (130), and an inference module (150).

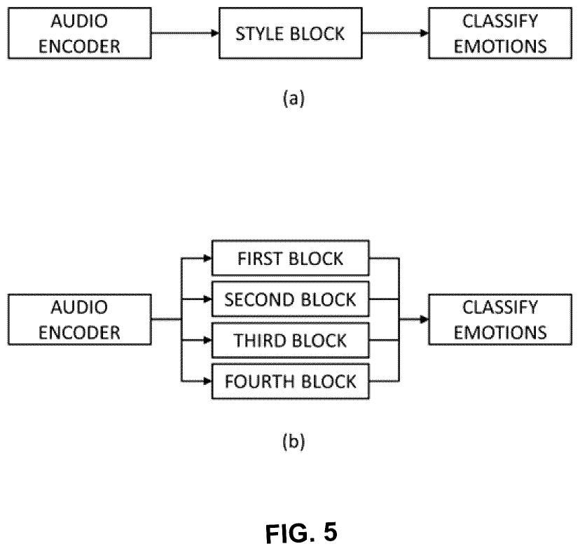

Referring to FIG. 5, the electronic device (100) according to an embodiment may include a pre-training module (110). Here, the pre-training module (110) may be a pre-trained model that training is completed with a large amount of dataset, thereby saving time and resources in a model training process for generating an audio-based animation. Here, the pre-training module (110) may be a pre-trained feature extractor, which may be the same as the pre-trained model described above. Hereinafter, for the convenience of description, the pre-training module (110) may be referred to as a pre-trained model (110) although it may be named as a pre-trained model or a pre-trained feature extractor.

Referring to (a) of FIG. 5, the pre-training module (110) may extract a feature vector value from a pre-trained audio dataset through an audio encoder. The pre-training module (110) may classify the pre-trained audio dataset into at least one of emotions based on the feature vector value.

The pre-training module (110) may classify the pre-trained audio dataset into at least one of emotions through a style block. Referring to (b) of FIG. 5, the style block may include a first block operating to classify the first emotion, a second block operating to classify the second emotion, a third block operating to classify the third emotion, and a fourth block operating to classify the fourth emotion.

The pre-training module (110) may extract a feature vector value from the pre-trained audio dataset and, based on the feature vector value, pre-train the first block by placing a first weight to determine whether the pre-trained audio dataset is the first emotion through the first block, pre-train the second block by placing a second weight to determine whether the pre-trained audio dataset is the second emotion through the second block, pre-train the third block by placing a third weight to determine whether the pre-trained audio dataset is the third emotion through the third block, pre-train the fourth block by placing a fourth weight to determine whether the pre-trained audio dataset is the fourth emotion through the fourth block.

The pre-training module (110) may receive the audio source and extract at least one audio-based animation control function for generating an emotion-adjustable animation. Based on the control function extracted from the pre-training module (110), the degree of emotion to be reflected in the animation may be adjusted. Since the control function is extracted from the audio source, it may contain information related to the emotion reflected in the audio source, and thus the degree of emotion to be reflected in the synthesized animation may be adjusted based on the control function.

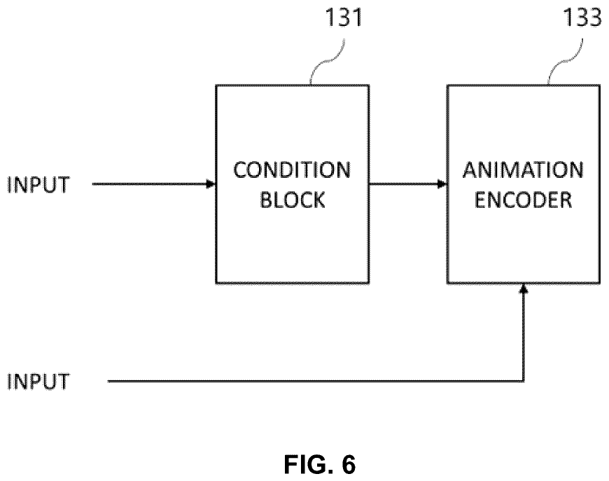

Referring to FIG. 6, the electronic device (100) according to an embodiment may include a training module (130). Here, the training module (130) may perform an operation of training a model to generate an animation reflecting an emotion based on an audio source from the pre-trained model.

The training module (130) may perform an operation of training to generate an animation reflecting emotions based on the audio source using the audio dataset and the animation dataset as training data.

The training module (130) may obtain the audio dataset and obtain the animation dataset. The training module (130) may extract audio features from the audio dataset, extract facial features from the animation dataset, generate a synthetic animation based on the audio features and the facial features, and then it may be trained to generate an animation which the emotion value is controlled.

The training module (130) may be trained based on a condition block (131) and an animation encoder (133). The training module (130) may extract at least one emotion variable from the audio source through the condition block (131) and may be trained to generate the animation reflecting the extracted emotion variable through the animation encoder (133).

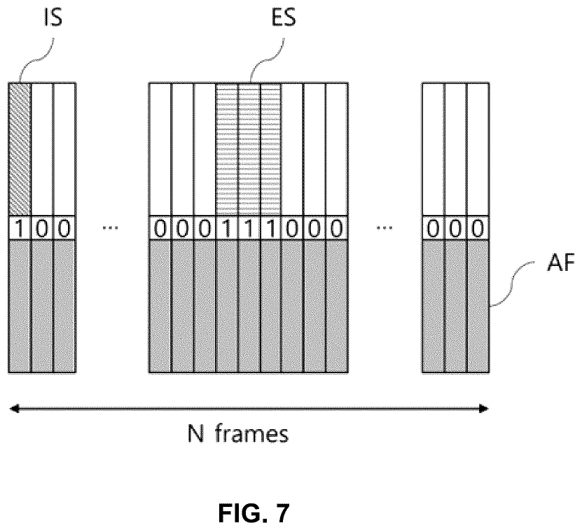

More specifically, referring to FIG. 7, the training module (130) may extract n frames from the audio dataset and may map the audio features to correspond to each of the n frames. The training module (130) may extract the emotion style based on the audio features mapped to each of the n frames and determine the emotion values based on the emotion styles.

The training module (130) may generate an animation based on the emotion values determined by the above method, and specifically, the training module (130) may be trained to generate the animation with controlled emotion values in the synthetic animation generated based on the audio source.

The training module (130) may determine the emotion styles based on the audio features. The training module determines that there is an emotion if the audio features are equal to or greater than a predetermined threshold value and determines that there is no emotion if the audio features are less than the threshold value.

The training module (130) may generate the synthetic animation by considering the initial state of the animation. Here, the initial state may be an initial setting value of various variables for controlling the facial expression of the animation. The facial expression of the animation may be determined based on the initial setting value, and an audio-based animation reflecting emotions may be generated from the determined facial expression value as a starting point.

The electronic device (100) may determine conditional features including multiple features and train the training module (130) to generate an animation with controllable emotion values based on the conditional features. The conditional features may include a first feature, a second feature, and a third feature.

The first feature may be determined based on a control function extracted from the audio source. More specifically, the electronic device (100) may input the audio source obtained from the user to the pre-training feature extractor to extract the audio-based control function and may determine the first feature based on the control function. The first feature may include a variable related to the emotion extracted from the audio source.

The second feature may be determined based on reference data. The reference data may be data used auxiliaryly to determine the emotion value. The reference data may be the data corresponding to the prompt described with reference to FIG. 3, and the electronic device (100) may perform an operation of generating the emotion animation by further considering variables related to emotions extracted from the reference data.

The third feature may be determined based on the animation data. The animation data may be the basis for generating the animation. The electronic device (100) may extract variables related to facial expressions and emotions from the animation data and generate an emotion animation reflecting the features obtained from the audio source.

The electronic device (100) may determine conditional features including at least one of the first to third features, and then train the training module (130) to generate an emotion-adjustable animation based on the conditional features.

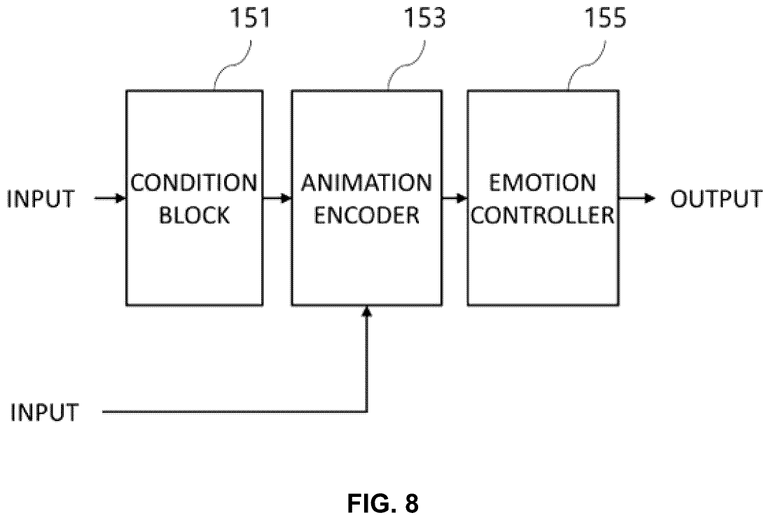

Referring to FIG. 8, the electronic device (100) according to an embodiment may include an inference module (150). Here, the inference module (150) may include a model that generates an animation reflecting emotions based on a user's input value (e.g., an audio source) through a pre-trained model.

The inference module (150) may obtain at least one input value from the user. The inference module (150) may obtain at least one of an audio source and a prompt from the user. The inference module (150) may generate an animation based on at least one of the audio source and the prompt obtained from the user, and the animation may implement voice reflecting emotions and facial expression changes reflecting emotions.

The inference module (150) may receive an audio source from the user and extract an audio feature based on analysis of the audio source. The inference module (150) may generate an animation reflecting the audio feature through the animation encoder (153) based on the extracted audio feature.

The inference module (150) may input at least one input value received from the user into a condition block (151) and classify at least one emotion from the input value. In addition to classifying at least one emotion from the input value through the condition block (151), the inference module (150) may extract emotion variables for each classified emotion.

The inference module (150) may generate an emotion animation, which is obtained through the animation encoder (153), reflecting an emotion variable determined by the aforementioned method.

The inference module (150) may control the above-mentioned emotion variables through an emotion controller (155). For example, the inference module (150) may determine multiple emotion styles from the audio source through the condition block (151) and may control the above-mentioned emotion variables by differentiating the weight for each of the emotion styles through the emotion controller (155).

The inference module (150) may extract emotion information based on the audio source and generate an animation based on the emotion information. It may generate an animation with more emphasized a target emotion. The target emotion may be determined based on user input, and the target emotion may be determined by controlling the weight for each of the multiple emotion styles.

For example, if a user wants to generate an animation with more emphasized the first emotion, the user may directly provide an input value related to the first emotion, and the inference module (150) may generate the animation with more emphasized the first emotion by adjusting the weights for the multiple emotion styles based on the input value.

The inference module (150) may further obtain a prompt from the user and may generate an animation by further considering an emotion value determined based on the prompts. Since the prompts and the operations related thereto have been described above, redundant explanations are omitted.

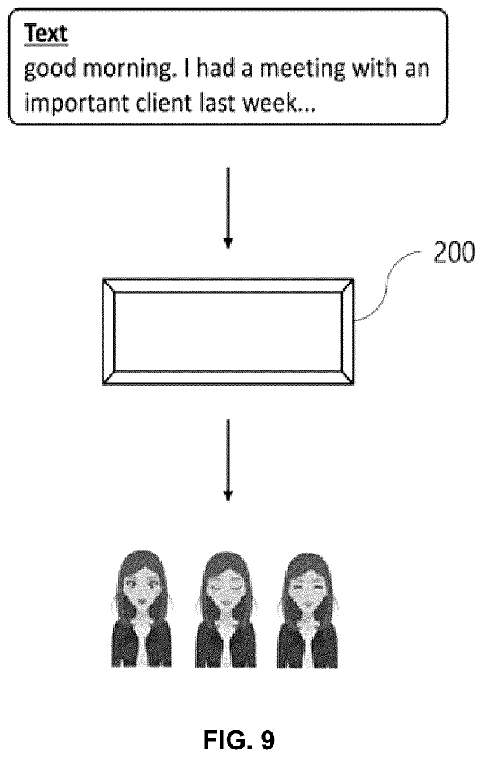

FIG. 9 is a diagram illustrating a method for generating an animation based on multimodal according to an embodiment. Referring to FIG. 9, the multimodal-based animation generation method according to an embodiment may obtain a question value from a user, determine an answer value for the question value through the animation generation device (200), and provide an animation generated based on the answer value to the user.

The animation generation device (200) may be an electronic device that includes a pre-trained model. The animation generation device (200) may be an electronic device driven by the pre-trained model. The animation generation device (200) may be an electronic device such as a user terminal or may be a server. Hereinafter, for the convenience of explanation, the animation generation device (200) is expressed as an electronic device.

The electronic device (200) may include a memory that stores one or more instructions, a communicator that communicates with an external device, an input/output interface that receives a user's input, and at least one processor that generates a control signal.

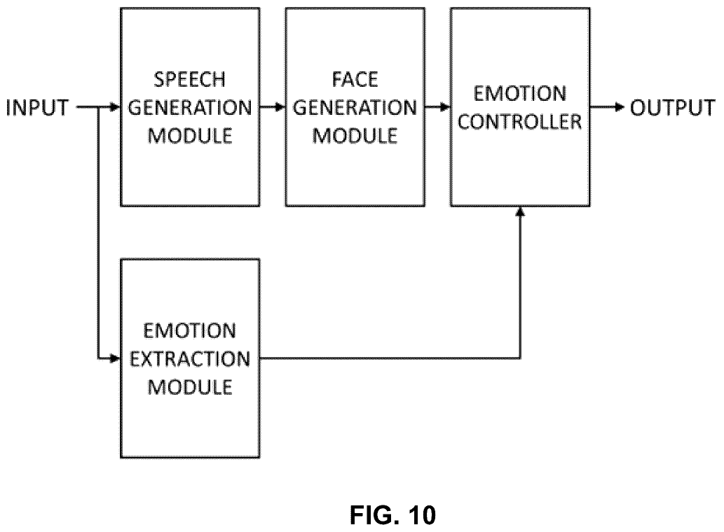

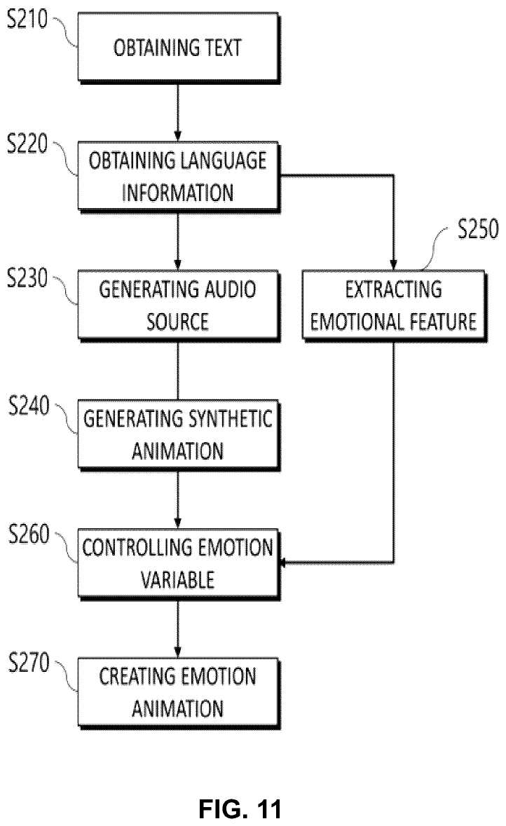

FIGS. 10 to 12 are diagrams showing a process for generating an animation based on multimodal according to an embodiment. Referring to FIGS. 10 and 11, the electronic device (200) may obtain an input value from a user and generate an audio source based on the input value through a speech generation module. The electronic device (200) may extract an emotion variable based on the input value through the emotion extraction module. The electronic device (200) may extract an emotion variable based on an output value (e.g., language information determined based on the input value) determined based on the input value through the emotion extraction module.

The electronic device (200) may generate an animation based on the audio source and the emotion variable through the face generation module, and the animation may be an animation reflecting the emotion.

The electronic device (200) may control the target emotion variable through the emotion controller. The electronic device (200) may generate an animation having a controlled target emotion variable by adjusting weights so that specific emotions can be emphasized in the animation.

More specifically, the electronic device (200) according to an embodiment may perform operations related to steps of obtaining text (S210), obtaining language information (S220), generating audio source (S230), generating synthetic animation (S240), extracting emotional feature (S250), controlling emotion variable (S260), and creating emotion animation (S270).

The electronic device (200) may obtain text from a user. The text may be a value obtained by a user input through an interface of a user terminal. The text may relate to the content of the user's conversation obtained in the dialogue window of the interface.

The electronic device (200) may extract language information based on text obtained from the user. The electronic device (200) may extract the language information based on a pre-trained model. The language information may be information corresponding to the text.

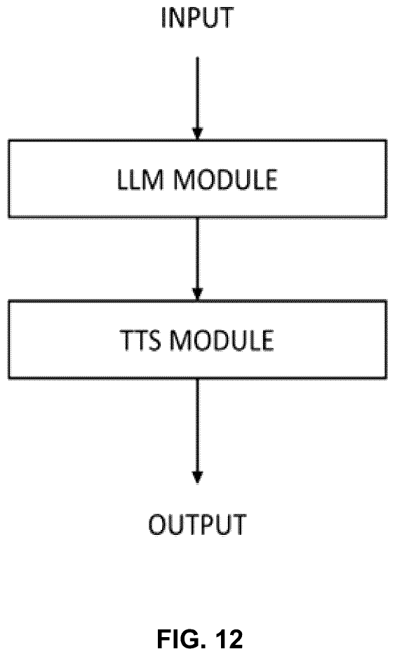

Referring to FIG. 12, the electronic device (200) may obtain input values from a user and obtain language information by inputting them into a first module. Here, the input value may be text data, and the first module may be a model equipped with a Large Language Model.

More specifically, the language information may be an answer value for the input value. The language information may be an answer generated by analyzing the user's input value through a language model. The answer may be in text form.

The electronic device (200) may receive language information obtained by the aforementioned method and extract text features through a pre-learned text model.

The electronic device (200) may generate an audio source based on language information (e.g., text data). Referring to FIG. 12, the electronic device (200) may generate an audio source by inputting the language information into the second module. Here, the second module may be a TTS (Text to Speech) module. The TTS module may be a module that receives a text source and converts it into an audio source, and may be performed by various known algorithms.

The electronic device (200) may generate a synthetic animation based on the audio source. The electronic device (200) may extract an audio feature from an audio source through the method mentioned above, and generate a synthetic animation based on the extracted audio feature.

The electronic device (200) may generate a synthetic animation based on the audio source and the language information. The electronic device (200) may generate a synthetic animation based on an audio feature extracted from the audio source and the text feature extracted from language information.

The electronic device (200) may generate a synthetic feature based on the audio feature and the text feature and may generate an animation based on the synthetic feature. The electronic device (200) may generate the synthetic feature by concatenating the text feature and the audio feature through a transformation module.

The electronic device (200) may generate a synthesized audio reflecting emotions based on the synthesized features and the text features. In other words, the electronic device (200) generates synthetic audio based on the synthetic features reflecting the audio and text features. The electronic device (200) may generate synthetic audio by further considering the text features to which weights are given for more precise control of the emotion value.

More specifically, the electronic device (200) may extract an emotion variable value from the text feature and generate synthetic audio by updating the extracted emotion variable value to the synthetic feature.

The electronic device (200) may generate a facial expression variable based on the synthesized audio and may generate an emotion animation based on the facial expression variable and the animation data.

The electronic device (200) may extract an emotion style. The electronic device (200) may extract the emotion style by the above-mentioned method based on the analysis of the language information. The electronic device (200) may extract the emotion style based on the analysis of the language information based on the pre-learned model.

The electronic device (100) may set an emotion variable value based on the emotion style. The emotion variable value may be determined by differentiating the weights for multiple emotions constituting the emotion style.

The electronic device (200) may generate an emotion animation by controlling the emotion variable in the synthetic animation.

More specifically, the electronic device (200) may generate a facial variable based on the audio source and generate a synthetic animation based on the facial variable and the audio source. Then, the electronic device (200) may generate an audio variable based on the emotion variable value and update the facial variable value based on the emotion variable value. Here, the audio variable may be a variable that controls emotions to be reflected in audio to be generated in the future.

The electronic device (200) may generate a target audio source based on the audio source and the audio variable and may generate an emotion animation based on the target audio source and the updated facial variable value. Here, the target audio source may be generated by reflecting an emotion style in the audio generated based on the language information, and through such a method, the emotion animation includes audio or facial expressions reflecting emotions.

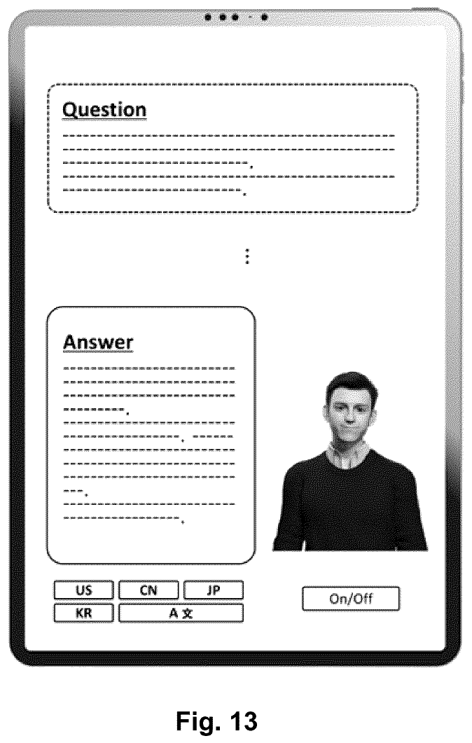

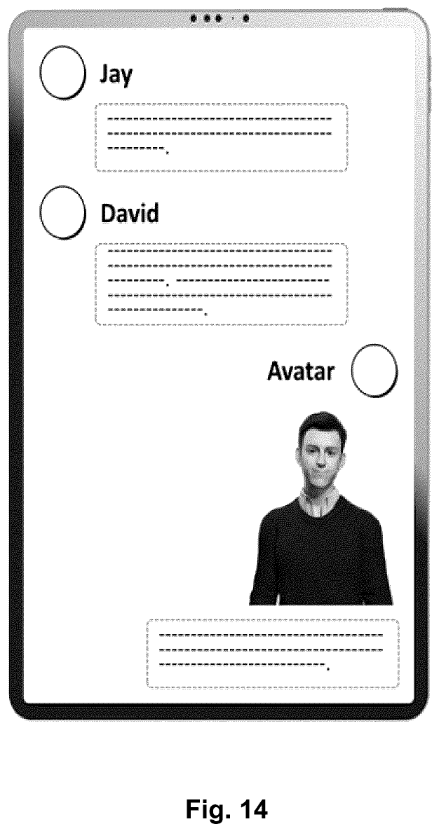

FIGS. 13 and 14 are diagrams illustrating specific examples of a multimodal-based animation generation method according to an embodiment. Referring to FIGS. 13 and 14, the electronic device (200) according to an embodiment may display a window for receiving a prompt from a user on a user interface. The user may input questions (or dialogues) they want to ask in the prompt, and, after receiving them, the electronic device (200) may generate an answer through a predetermined model (e.g., Large Language Model) and output it to the user interface.

The electronic device (200) may output the information associated with the answer through the user interface. The electronic device (200) may output the information associated with the answer in at least one of the formats of text output and audio output through the user interface.

The electronic device (200) may output the information related to the answer in an animation form on the user interface. The animation form may reflect voice and facial expression values, and the voice and facial expression values may reflect emotion values determined in the above-described method.

The electronic device (200) may obtain a prompt from a user, output an animation generated based on the prompt in a first area of the user interface, and output text generated based on the prompt in a second area. Here, the first area and the second area may be arranged vertically or in other arrangements.

The electronic device (200) may output an animation in the second area, and the animation may reflect voices and facial expressions determined based on the text. The animation may further reflect an emotion variable determined based on the text.

The electronic device (200) may output either the animation or the text based on the user input. The electronic device (200) may change state information of the animation based on the user input. Here, the state information of the animation may include at least one of a type of animation, a voice of the animation, a facial expression of the animation, and an emotion variable value of the animation.

The electronic device (200) may determine the emotion variable value of the animation based on the user input. For example, when the electronic device (200) obtains an input for an object that induces the first emotion to be emphasized from the user, the electronic device (200) may control the emotion variable value so that the first emotion can be further emphasized based on the input value, and output the animation in a different manner by controlling the emotion variable value.

Although the invention has been described with respect to specific embodiments, it will be appreciated that the invention is not necessarily limited to such embodiments and is intended to cover all modification and equivalents within the scope of the following claims. Furthermore, the features, structures, and effects illustrated in the embodiments are merely exemplary and are not intended to be exhaustive or limited to such embodiment disclosed. Many modifications and variations will be apparent to a person having ordinary skill in the art in view of the above teachings without departing from the scope and spirit of the invention. Therefore, such modifications and variations should be interpreted as being included in the scope of the present invention associated with the claims below.

What is claimed is:

1. A audio-based animation generation device capable of adjusting emotions, the device comprising:
a memory storing one or more instructions; and
at least one processor, wherein the at least one processor performs operations of receiving an audio source by executing the stored instructions; inputting the audio source into a pre-training feature extractor to extract at least one voice-based control function for generating an emotion-adjustable animation; determining conditional features through at least one first feature extracted based on the control function, at least one second feature extracted based on reference data, and at least one third feature extracted based on animation data; training a training module to generate an emotion-adjustable animation based on the conditional features; and generating an emotion animation through an reference module based on a target audio source and a target image input value,
wherein the emotion animation is capable of adjusting a degree of emotion based on the control function.

2. The device of claim 1, wherein the pre-training feature extractor is pre-trained through an operation including extracting feature vector values from the audio source using an audio encoder and classifying the audio source into at least one emotion based on the feature vector values through a style block.

3. The device of claim 2, wherein the style block includes a first block operating to classify a first emotion, a second block operating to classify a second emotion, a third block operating to classify a third emotion, and a fourth block operating to classify a fourth emotion.

4. The device of claim 3, wherein the at least one processor is pre-trained:
by placing a first weight value, to determine the audio source as the first emotion through the first block based on the feature vector values;
by placing a second weight value, to determine the audio source as the second emotion through the second block based on the feature vector values;
by placing a third weight value, to determine the audio source as the third emotion through the third block based on the feature vector values;
by placing a fourth weight value, to determine the audio source as the fourth emotion through the fourth block based on the feature vector values.

5. The device of claim 1, wherein the at least one processor trains the training module through an operation of extracting audio features from the audio source, an operation of extracting facial expression features from the animation data, and an operation of generating an emotion-controlled animation based on at least one of the first feature and the second feature and the audio features and the facial expression features.

6. The device of claim 5, wherein the at least one processor extracts n frames from the audio source, maps the audio features to each of the n frames, extracts emotion styles based on the audio features mapped to each of the n frames, and determines the emotion values based on the emotion styles.

7. The device of claim 6, wherein the emotion style is determined to have emotion if the audio feature is equal to or greater than a predetermined threshold value, and the emotion style is determined to have no emotion if the audio feature is less than the threshold value.

8. The device of claim 1, wherein generating the emotion animation includes extracting a target audio feature by using the target audio source as an input value and determining a target emotion style, determining a target emotion value based on the target emotion style, and generating an emotion animation reflecting the target audio feature and the target emotion value based on the target image.

9. The device of claim 8, wherein the at least one processor generates the emotion animation by controlling the target emotion value, and the target emotion value is controlled by assigning different weights to multiple emotion styles.

10. The device of claim 8, wherein the at least one processor obtains at least one prompt, determines an emotion variable based on the at least one prompt, and determines the target emotion value based on the emotion variable, and the reference data is determined based on the at least one prompt.

11. The device of claim 10, wherein the prompt is provided in at least one of a text form, an image form, a video form and an animation form, and the target emotion value is determined by considering different weights based on the emotion variable.

12. A method of generating an audio-based animation capable of adjusting an emotion value, the method comprising:
receiving an audio source;
extracting at least one audio-based control function for generating an emotion adjustable animation by inputting the audio source to a pre-training feature extractor;
determining a conditional feature through at least one first feature extracted based on the control function, at least one second feature extracted based on reference data, and at least one third feature extracted based on animation data;
training a training module to generate an emotion adjustable animation based on the conditional feature; and
generating an emotion animation based on a target audio source and a target image input value through an inference module, wherein the emotion animation may adjust a degree of emotion based on the control function.
